(19) United States
(12) Patent Application Publication
(10) Pub. No.: US 2026/0352067 A1
(43) Pub. Date: Nov. 5, 2026

(54) CURRENT TRANSMISSION DEVICE FOR TRANSMITTING ELECTRICAL CURRENT TO A ROTOR OF AN ELECTRIC MACHINE

(71) Applicant: Schaeffler Technologies AG & Co. KG, Herzogenaurach (DE)

(72) Inventors: Oliver WITTER, Westhausen (DE); Marcus ROMEIS, Leinburg (DE); David LANG, Bubenreuth (DE)

(73) Assignee: Schaeffler Technologies AG & Co. KG, Herzogenaurach (DE)

(21) Appl. No.: 19/486,149

(22) PCT Filed: Apr. 19, 2024
(86) PCT No.: PCT/DE2024/100339

§ 371 Date: Nov. 20, 2025

(30) Foreign Application Priority Data
May 24, 2023 (DE) 10 2023 113 582.1

(51) Int. Cl. H02K 9/28

(52) U.S. Cl. CPC H02K 9/28

(57) ABSTRACT

A current transmission device for transmitting electrical current to a rotor of an electric machine, having two contact carriers which each carry electrical sliding contacts for transmitting current to the rotor, wherein a base carrier which carries and electrically insulates the contact carriers is arranged between said contact carriers, wherein the current transmission device has at least one coolant channel, wherein at least one closed circumferential coolant channel for cooling the two contact carriers is arranged at the elements of base carrier and contact carrier, which bear against one another at least in portions, between each outer side of the base carrier and the contact carrier resting thereagainst, in such a way that there is provided on the base carrier, on its outer side facing the respective contact carrier, a ribbed structure open on one side and projecting from the surface

### CROSS-REFERENCE TO RELATED APPLICATIONS

This application is the U.S. National Phase of PCT Appln. No. PCT/DE2024/100339, filed Apr. 19, 2024, which claims the benefit of German Patent Appln. No. 102023113582.1, filed May 24, 2023, the entire disclosures of which are incorporated by reference herein.

### TECHNICAL FIELD

The disclosure relates to a current transmission device for transmitting electrical current to a rotor of an electric machine, having two contact carriers which each carry electrical sliding contacts for transmitting current to the rotor, wherein a base carrier which carries and electrically insulates the contact carriers is arranged between the contact carriers, wherein the current transmission device has at least one coolant channel.

### BACKGROUND

The publication DE 10 2021 122 065 B3 is considered to be the closest prior art. A current transmission device having a base carrier and contact carriers on both sides with respective brushes is described therein. According to FIG. 6, starting from a lateral inlet, the base carrier has a transverse and a radial channel for coolant, which leads to outlets on both sides slightly above the rotor opening, on its inner wall.

DE 10 2019 100 729 B4 discloses a brush module for a slip ring system of a current-excited electric machine for a motor vehicle for energizing a rotor of the electric machine. A heat-conducting core enclosed in a holding device for holding the brush carrier is intended to dissipate heat from the brush module.

Reference is further made to the publications DE 93 01 792 U1, DE 69 36 266 U and GB 967 623 A.

### SUMMARY

The disclosure is based on the object of proposing a current transmission device of the aforementioned type, which allows for improved cooling of the sliding contacts of an electric machine, in particular with respect to performance and operational safety, in a structurally simple and cost-effective manner.

In accordance with the disclosure, this object is achieved in that at least one closed circumferential coolant channel for cooling the two contact carriers is formed at the elements of base carrier and contact carrier, which bear against one another at least in sections, between each outer side of the base carrier and the contact carrier bearing thereagainst, in such a way that on the base carrier, on its outer side facing the respective contact carrier, a ribbed structure open on one side and projecting from the surface is provided, which ribbed structure, together with the respective contact carrier bearing thereagainst and covering it in a coolant-tight manner on its axially open side, forms the closed circumferential coolant channel.

This is a simple and cost-effective way of improving the cooling of the electrical sliding contacts of an electric machine, in particular with respect to performance and operational safety. Through the interaction of the elements of base carrier and the respective contact carrier, at least one closed circumferential coolant channel is formed between each outer side of the base carrier and the respective contact carrier bearing thereagainst without the need for additional components. A targeted active cooling of the two contact carriers and the electrical sliding contacts carried by them can be achieved with a high cooling capacity thanks to targeted channel routing.

The at least one closed circumferential coolant channel formed in this way between each outer side of the base carrier and the respective contact carrier bearing thereagainst can be flowed through by coolant in a closed path without coolant entering the surroundings in an uncontrolled manner.

Accordingly, uncontrolled contact of the electrical sliding contacts with the coolant is avoided, which means that the cooling of the electrical sliding contacts can be designed independently of their lubrication. In particular, with increasing cooling capacity and increasing coolant flow, uncontrolled subjecting of the electrical sliding contacts to coolant, in particular so-called floating of the electrical sliding contacts, can be avoided, which reliably prevents malfunctions in the operation of the electric machine caused by this.

According to a further development of the disclosure, the respective ribbed structures are formed by at least two ribs projecting from the surface, wherein the ribs are each arranged opposite one another and circulate in a closed manner such that they define between them a closed circumferential coolant channel which is open on one side and is covered in a coolant-tight manner on the open side by a contact carrier bearing thereagainst.

In this regard, it is also advantageous if the ribs preferably form a sealing surface at each end face of their axially projecting free ends. Preferably, the respective contact carrier bears in a coolant-tight manner against the sealing surfaces of two oppositely arranged ribs here.

The design of the disclosure can be further simplified if the contact carriers are preferably designed as plates. In this context, the contact carriers can each bear axially, in a coolant-tight manner, with a flat axial inner side against planar sealing surfaces of the coolant-carrying ribbed structures formed on the axial outer sides of the base carrier facing away from one another and can each easily cover a coolant channel formed therebetween, which is open on one side, in a coolant-tight manner towards the outside on the open side.

In an advantageous further development of the disclosure, the coolant channels formed on the outer sides of the base carrier at the coolant-carrying ribbed structures in each case are in coolant connection with one another. This advantageously makes it possible to form a common coolant inlet and a common coolant outlet on one of the outer sides of the base carrier so that the coolant channels on both outer sides of the base carrier can be connected to a coolant supply, in particular to the oil circuit of the electric machine, from one outer side of the base carrier.

In a further advantageous further development of the disclosure, on an outer side of the base carrier, the coolant inlet and the coolant outlet are each passed through the contact carrier bearing thereagainst axially to the outside and projecting on the latter, preferably in the form of a tubular extension, for example as a connecting piece.

Preferably, the coolant inlet and the coolant outlet are formed in a manner aligned inwards with the respective extension and then pass through the base carrier to the other outer side of the base carrier in the manner of a breakthrough in such a way that the respective breakthrough opens directly into the coolant channel formed on the ribbed structure on this outer side of the base carrier.

Alternatively, a respective coolant drain opening can be formed on each outer side of the base carrier at the geodetically lowest point on the ribbed structures for drainage by way of gravity on the ribbed structures. Preferably, the drain openings are, in this regard, each formed on an outer rib of the ribbed structures, which is arranged furthest away from a central through-opening on the base carrier for the passage of a shaft carrying the rotor in relation to the inner rib of the ribbed structures. This prevents uncontrolled contamination of the electrical sliding contacts with coolant. In this context, a common coolant inlet as described above is preferably provided for the coolant channels formed on both axial outer sides of the base carrier on the respective ribbed structures.

Multiple through-holes extending between the axial outer sides of the base carrier are preferably provided for the coolant connection, each of which opens directly into the coolant channels formed on the coolant-carrying ribbed structures on the axial outer sides of the base carrier facing away from one another in each case. In this manner, both coolant channels are connected to form a cooling circuit.

As part of a further development of the disclosure, the coolant channels formed on the outer sides of the base carrier on the coolant-carrying ribbed structures in each case are formed such as to be congruent with one another and offset in the circumferential direction. This further simplifies the structure and production of the base carrier.

It is furthermore advantageous if, in a top view in each case, the coolant channels formed on the outer sides of the base carrier on the coolant-carrying ribbed structures in each case extend in a meandering manner with multiple loops arranged circumferentially one behind the other. In this manner, a particularly even and comprehensive cooling with a particularly high cooling capacity can be achieved.

A further advantage is preferably achieved in this context in that at least some of the loops extend, at least in part, in contact with the regions on the inner sides of the contact carriers on which the electrical sliding contacts are arranged on the outer sides of the contact carriers. This makes it easy to achieve a targeted active cooling of the regions of the contact carriers that heat up the most during operation.

According to a possible next further development of the disclosure, spray openings aligned in a targeted manner are, in each case, provided on the ribbed structures for the controlled minimum lubrication of the electrical sliding contacts. Preferably, at least one spray opening is, in each case, aimed at the respective electrical sliding contact in a targeted manner here. In this context, the minimum lubrication can be adjusted in a controlled manner by the design of the spray openings. The spray openings are preferably each formed on the base carrier as a channel open on one side, which is covered in a coolant-tight manner by the contact carrier bearing thereagainst in each case.

In the proposed current transmission device, plastic is preferably provided as the material for the base carrier, which allows for a particularly simple, weight-saving and cost-effective production, in particular by means of injection molding.

Preferably, the base carrier is formed in one piece as an injection-molded component, which has a simple design for production with an injection mold and can be easily removed from it, and in particular has no undercuts. This makes the base carrier particularly easy to pre-assemble with the contact carriers and the proposed current transmission device can be pushed axially onto the rotor shaft of the electric machine as a pre-assembled component with the central through-opening and easily attached to a stationary component, in particular the stator housing of the electric machine.

### BRIEF DESCRIPTION OF THE DRAWINGS

The disclosure is explained below on the basis of the drawings. In the drawings:

FIG. 1 shows a perspective view of a current transmission device according to the disclosure for transmitting electrical current to a rotor of an electric machine,

FIG. 2 shows a top view of the current transmission device on a first axial outer side,

FIG. 3 shows a top view of the current transmission device on a second axial outer side,

FIG. 4 shows a single perspective view of a base carrier of the current transmission device,

FIG. 5 shows a top view of the base carrier on a first axial outer side,

FIG. 6 shows a top view of the base carrier on a second axial outer side,

FIG. 7 shows a top view of the base carrier on a first axial outer side with a first contact carrier of the current transmission device indicated by dashed lines,

FIG. 8 shows a top view of the base carrier on a second axial outer side with a second contact carrier of the current transmission device indicated by dashed lines.

### DETAILED DESCRIPTION

The figures show, by way of example, various views and embodiments of a current transmission device according to the disclosure for transmitting electrical current to a rotor of an electric machine.

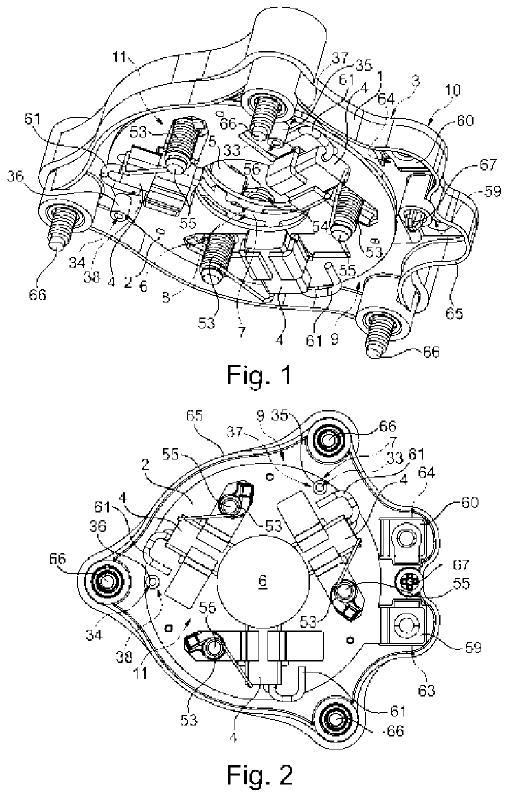

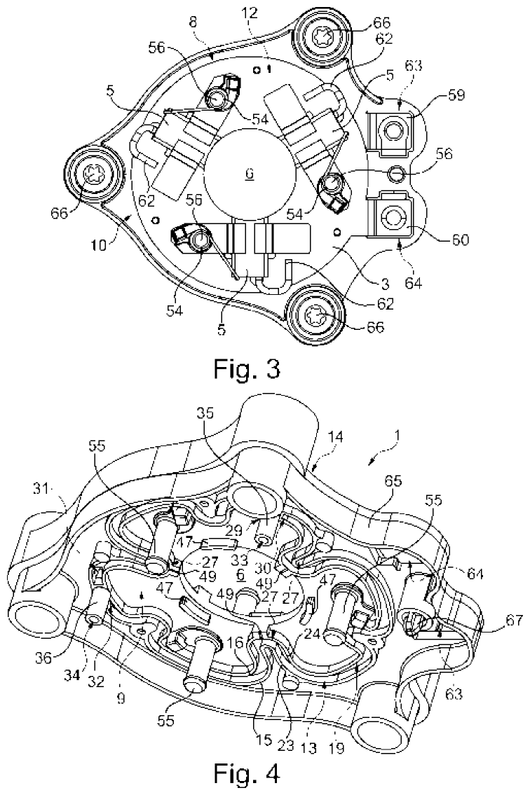

According to FIGS. 1 to 3, the current transmission device comprises a base carrier 1 formed in one piece and two contact carriers 2, 3, each of which carries three electrical sliding contacts 4, 5 for transmitting electrical current to the rotor. The base carrier 1 is arranged between the contact carriers 2, 3, carrying and electrically insulating them, in a manner coaxial with the contact carriers 2, 3. The base carrier 1 and the contact carriers 2, 3 form a central through-opening 6 on the current transmission device to be arranged in a fixed manner for the passage of a shaft of the electric machine carrying the rotor.

The base carrier 1 and the contact carriers 2, 3 are designed to be plate-like. The contact carriers 2, 3 are preferably designed as circular contact plates. With their planar inner sides 7, 8 facing axially towards the base carrier 1, they are secured to the axial outer sides 9, 10 of the base carrier 1 facing away from one another, for example by means of axial screw connections. On the axial outer sides 11, 12 of the contact carriers 2, 3 facing away from one another, the electrical sliding contacts 4, 5 are arranged in a manner evenly distributed over the circumference and secured.

In order to dissipate the heat generated on the electrical sliding contacts 4, 5 during operation, a closed circumferential coolant channel 19, 20 is formed, in each case, on the surfaces of the base carrier 1 on the axial outer sides 9, 10 of the same and on the surfaces of the contact carriers 2, 3 in order to cool the contact carriers 2, 3.

In order to form the coolant channels 19, 20, ribbed structures 13, 14 axially open on one side are provided on the axial outer sides 9, 10 of the base carrier 1 in each case (FIGS. 4 to 6). These are each formed by two ribs 15, 16 and 17, 18, which are formed in one piece with the base carrier 1 and project vertically and axially from the planar axial outer sides 9, 10 of the same.

The ribs 15, 16 and 17, 18 each form a closed circumferential boundary wall and are arranged opposite one another continuously at the same distance from one another so that they each define a closed circumferential coolant channel 19, 20 between them, which is open axially to the outside. In this regard, the axially open sides 21, 22 of the cooling channels 19, 20 are each covered in a coolant-tight manner by the contact carrier 2, 3 bearing axially thereagainst in each case (FIGS. 1 to 3).

In this way, on a first axial outer side 9 of the base carrier 1, the ribs 15, 16 with a first contact carrier 2 bearing axially thereagainst form a closed circumferential first coolant channel 19 and, on the second axial outer side 10 of the base carrier 1, the ribs 17, 18 with a second contact carrier 3 bearing axially thereagainst form a closed circumferential second coolant channel 20. Preferably, the coolant channels 19, 20 are circumferentially sealed in a coolant-tight manner with respect to the surroundings in this respect.

For sealing purposes, the ribs 15, 16 and 17, 18 each form a planar sealing surface 23, 24 and 25, 26 (FIGS. 4 to 8) at the end faces of their freely axially projecting ends, against which the respective contact carrier 2, 3 axially bears in a coolant-tight manner with the respective planar axial inner side. If necessary, appropriate seals can also be provided for additional sealing.

In this manner, the contact carriers 2, 3 are also axially supported on the ribs 15, 16 and 17, 18. For further support, circularly extending support ribs 47 and 48 can be provided, as shown, on both axial outer sides 9, 10 of the base carrier 1 formed in one piece with the base carrier 1. The support ribs 47 or 48 on each outer side 9, 10, preferably three in each case, are arranged evenly distributed in the region of the circular central through-opening 6 coaxially to the latter in the circumferential direction. In this manner, the contact surface on the base carrier 1 for supporting the contact carriers 2, 3 can be kept small and thus the heating of the same can be kept low.

On the axial outer sides 9, 10 of the base carrier 1, the ribs 15, 16 and 17, 18 and the coolant channels 19, 20 formed therebetween each extend in the axial top view in a meandering manner in the circumferential direction with multiple loops arranged one behind the other (FIGS. 4 to 8). In each case, the inner ribs 16 and 18 extend closer to the central through-opening 6 and the outer ribs 15 and 17 further away from it in this respect. This channel routing allows for a uniform active cooling of the contact carriers 2, 3 and the electrical sliding contacts 4, 5 arranged on them with a high cooling capacity.

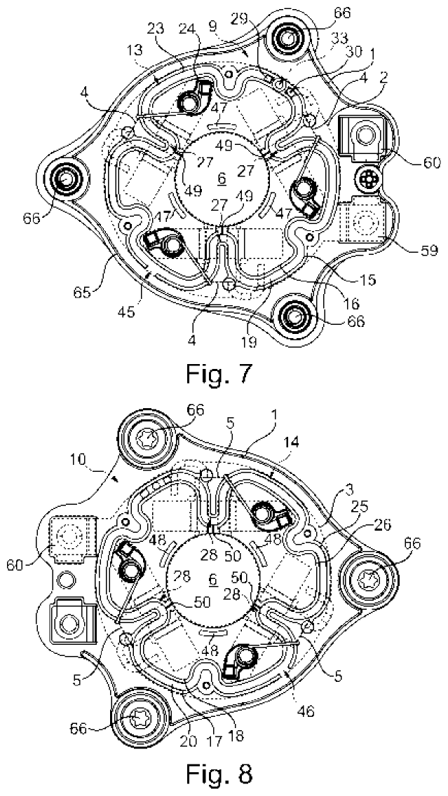

In this regard, the coolant channels 19, 20 are routed in such a way that preferably three inner loops 27 or 28 are formed in each case, each extending particularly far inwards towards the central through-opening 6, so that they each extend in contact with the regions on the inner sides 7, 8 of the contact carriers 2, 3, on which the electrical sliding contacts 4 or 5 are arranged on the outer sides 7, 8 of the contact carriers 2, 3 (FIGS. 7 and 8). Accordingly, the channel routing of the coolant channels 19, 20 allows for a targeted cooling of the regions of the contact carriers 2, 3 where the greatest heat is generated in a simple manner.

According to FIGS. 4 to 6, multiple through-hole openings 29, 30 or 31, 32 extending between the axial outer sides 9, 10 of the base carrier 1 are preferably provided for the coolant connection, each of which opens directly into the coolant channels 19, 20 formed in each case on the ribbed structures 13, 14 on the axial outer sides of the base carrier 1 facing away from one another.

Accordingly, the coolant channels 19, 20 form a common cooling circuit, which can be connected to a coolant supply of the vehicle on the first axial outer side 9 of the base carrier via a common coolant inlet 33 and a common coolant outlet 34. Oil from the transmission oil circuit of the electric machine can be used as a coolant, for example.

The coolant inlet 33 and the coolant outlet 34 are each formed as a tubular extension 35, 36 projecting axially outwards on the outer sides 9, 10, for example as a connecting piece, preferably in one piece with the base carrier 1 (FIGS. 1, 2 and 4). With the extensions 35, 36, the coolant inlet 33 and the coolant outlet 34 are each passed through the contact plates 2, 3 at the through-openings 37, 38 to the outer sides 7, 8 of the same in an axially projecting manner (FIG. 1).

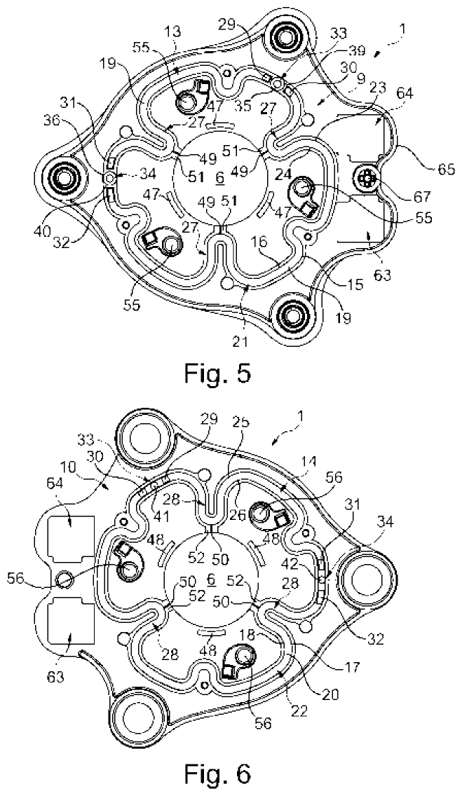

In the region of the coolant inlet 33 and the coolant outlet 34, the ribs 15, 16 are each connected to one another by a connecting web 39, 40 terminating with them in a flush manner at the free axial end faces, which interrupts the coolant channel 19 (FIGS. 4 and 5). The connecting webs 39, 40 are formed in one piece with the ribs 15, 16 and the base carrier 1.

In the axially inner direction, the coolant inlet 33 and the coolant outlet 34 each extend, in this respect, from the respective connecting web 39, 40 in an axially aligned manner with the respective extension 35, 36 as an axial breakthrough 41, 42 on the base carrier 1 to the second axial outer side 10 of the same and open directly into the coolant channel 20 formed there (FIG. 6).

The connecting webs 39, 40 form planar sealing surfaces 43, 44 on their axial end faces, which merge in a planar manner into the sealing surfaces 23, 24 on the end faces of the ribs 15, 16 in each case. The contact carrier 2 bears against the base carrier 1 axially in a coolant-tight manner at the sealing surfaces 43, 44 and seals the region of the through-openings 37, 38 on the contact carriers 2, 3.

The through-holes 29, 30 or 31, 32 for the coolant connection of the coolant channels 19, 20 have a rectangular cross-sectional profile and are positioned in the coolant channel 19 on both sides of the connecting webs 39, 40 directly adjoining them (FIGS. 4 and 5).

The coolant entering at the coolant inlet 33 on the first axial outer side 9 of the base carrier 1 first enters the second coolant channel 20 on the second axial outer side 10 of the base carrier 1 via the breakthrough 41 and can be distributed in both channel or circulation directions. It can flow into the first coolant channel 19 on the first axial outer side 9 and back to the second coolant channel 20 via the coolant connection at the through-holes 29, 30 or 31, 32 and drain off at the coolant outlet 34 via the breakthrough 42 and the extension 36 on the first axial outer side 10 of the base carrier 1.

Alternatively, as shown in FIGS. 7 and 8, a coolant drain opening 45, 46 can be formed on each axial outer side 9, 10 of the base carrier 1 on the ribbed structures 13, 14, which is preferably arranged at the geodetically lowest point for drainage by way of gravity. In this regard, corresponding drain openings 45, 46 are preferably formed in each case on the outer rib 15 or 17 of the respective ribbed structures 13, 14 in order to avoid uncontrolled contamination of the electrical sliding contacts 4, 5 with coolant in the region of the central through-opening 6.

In order to be able to implement a minimum lubrication of the electrical sliding contacts 4 or 5 on the contact carriers 2, 3 via the cooling channels 19, 20 formed by the coolant-carrying ribbed structures 13 or 14, it is possible in a further alternative embodiment, as shown in FIGS. 4 to 6, to provide spray openings 49 or 50 formed on the coolant-carrying ribbed structures 13 or 14 on both axial outer sides 9, 10 of the base carrier 1 in each case. The spray openings 49 or 50 are each assigned to an electrical sliding contact 4 or 5. At the spray openings 49 or 50, spray oil from the coolant circuit can be distributed to the electrical sliding contacts 4 or 5 in a targeted and controlled manner.

The spray openings 49 or 50 are each arranged in a manner originating from the inner ribs 16 or 18 on the inner loops 27 or 28 facing the central through-opening 6 in the region of the apex thereof. In order to achieve a targeted alignment of the spray openings 49 or 50 and guidance of the spray oil, these are each formed as a channel extending from the outer ribs 15 or 17 in each case, which extends straight up to the central through-opening 6 and is aligned at the end with the respective electrical sliding contact 4 or 5 in a targeted manner.

For this purpose, extensions 51 or 52 are provided on the outer sides of the outer ribs 15 or 17 in the direction of the central through-opening 6 extending in one piece with the through-opening and the base carrier 1, which on their axial outer sides each form an axially outwardly open spray channel at a recess, which is covered in a coolant-tight manner on the open side by the respective contact carriers 2, 3 bearing thereagainst. In this regard, the extensions 51 and 52 extend to the edge of the central through-opening 6 and terminate at the axial end faces in a flush manner with the free end-facing ends of the ribs 15 and 17 on the one hand and with the central through-opening 6 on the other.

For retaining press-on means 53 or 54, in particular spring means, preferably helical coil springs, for pressing on the sliding contacts 4 or 5, retaining pins or bolts 55 or 56, preferably formed in one piece with the base carrier, are provided on both axial outer sides of the base carrier 1 (FIGS. 1 to 3). These are guided through the contact carriers in an axially projecting manner on the axial outer sides of the base carrier 1. A helical coil spring 53 or 54 is axially attached to each of the retaining pins 55 or 56 and, with a free spring leg, biases the respective electrical sliding contact 4 or 5 inwards in the direction of the central through-opening 6 (FIG. 1).

The base carrier 1 is made of an electric insulating material, preferably plastic. In particular considering the coolant-carrying ribbed structures 13, 14, it has, in this context, a particularly simple design, especially without an undercut, as an injection-molded component and can thus be easily produced with an injection mold and easily removed from it. Accordingly, the base carrier 1 can be produced particularly easily and cost-effectively in one piece by means of injection molding.

The contact carriers 2, 3 are made of an electrically conductive material, in particular metal, preferably non-ferrous metal, for example brass. They can be produced particularly easily and cost-effectively in sheet metal, in particular by punching and bending in one piece as punch-and-bend components. According to FIGS. 1 to 3, the contact carriers 2, 3 are each connected to an electrical supply, in particular to the electrical system of a vehicle, via an electrical connecting tab 59 or 60 with electrical contacts which is formed in one piece with them. Accordingly, the contact carriers 2, 3 are current-carrying so that the electrical sliding contacts 4 and 5 can each be electrically connected in a simple manner via connecting wires 61 and 62 connected to the respective contact plate 2, 3, preferably by means of material bonding, for example by soldering or welding. The electrical sliding contacts 4 and 5 are preferably designed as electrically conductive so-called brushes, which produce the electrical contact to a slip ring, not shown, arranged on the rotor shaft for the electrical power supply of the rotor.

According to FIGS. 1 to 3 and 5 to 8, axial breakthroughs 63, 64 are provided on the base carrier 1 corresponding to the electrical connecting tabs 59 and 60 of the contact carriers 2, 3 arranged next to one another, to which the electrical contacts of the connecting tabs 59 and 60 of both contact carriers 2, 3 can be electrically connected particularly easily from an axial outer side 9, 10, preferably from the second outer side 10 of the electrical base carrier 1, for example by plugging on cable lugs.

According to FIGS. 1, 2, 4, 5 and 7, a circumferential housing wall 65 freely projecting on the first axial outer side 9 is formed in one piece with the base carrier 1. It has multiple, preferably three, axial screw connections 66 integrated into the housing wall 65 at the outer edge (FIGS. 1 to 3), which are arranged evenly distributed over the circumference and project from the first axial outer side 9. With the screw connections 66 and with the mounting aid 67, the current transmission device can be fixed in a centered position on the electric machine, preferably on the stator housing.

Here, the base carrier 1 with the pre-assembled contact carriers 2, 3 can be pushed onto the central through-opening 6 on the rotor shaft of the electric machine and screwed onto the stator housing with the first axial outer side 9, i.e., the rear side of the base carrier 1 or the current transmission device. In this regard, the coolant inlet 33 and the coolant outlet 34 can also be connected to the first axial outer side 9, for example to the transmission oil circuit of the electric machine. Both contact plates 2, 3 can be electrically connected to the connecting tabs 55, 56 on the free second axial outer side 10, i.e., the front side of the base carrier 1 or the current transmission device.

### LIST OF REFERENCE SYMBOLS

1 Base carrier
2 First contact carrier
3 Second contact carrier
4 Sliding contact
5 Sliding contact
6 Through-opening
7 Inner side of the first contact carrier
8 Inner side of the second contact carrier
9 First outer side of the base carrier
10 Second outer side of the base carrier
11 Outer side of the first contact carrier
12 Outer side of the second contact carrier
13 Ribbed structure
14 Ribbed structure
15 Outer rib
16 Inner rib
17 Outer rib
18 Inner rib
19 First coolant channel
20 Second coolant channel
21 Open side
22 Open side
23 Sealing surface
24 Sealing surface
25 Sealing surface
26 Sealing surface
27 Inner loop
28 Inner loop
29 Through-hole
30 Through-hole
31 Through-hole
32 Through-hole
34 Coolant outlet
35 Extension, connecting piece
36 Extension, connecting piece
37 Through-opening
38 Through-opening
39 Connecting web
40 Connecting web
41 Breakthrough
42 Breakthrough
43 Sealing surface
44 Sealing surface
45 Opening
46 Opening
47 Support rib
48 Support rib
49 Spray opening
50 Spray opening
51 Extension
52 Extension
53 Press-on means, spring means, helical coil spring
54 Press-on means, spring means, helical coil spring
55 Retaining pin or bolt
56 Retaining pin or bolt
57 Not assigned
58 Not assigned
59 Connecting tab
60 Connecting tab
61 Connecting wire
62 Connecting wire
63 Breakthrough
64 Breakthrough
65 Housing wall
66 Screw connection
67 Mounting element

1. A current transmission device for transmitting electrical current to a rotor of an electric machine, comprising:
two contact carriers which each carry electrical sliding contacts, for transmitting current to the rotor, and a base carrier which carries and electrically insulates the contact carriers arranged between the contact carriers,
wherein at least one closed circumferential coolant channel for cooling the two contact carriers is formed at the base carrier and each contact carrier, which bear against one another at least in sections, between each outer side of the base carrier and a respective contact carrier bearing thereagainst, in such a way that on the base carrier, on its outer side facing the respective contact carrier, a ribbed structure open on one side and projecting from a surface is provided, which ribbed structure, together with the respective contact carrier bearing thereagainst and covering it in a coolant-tight manner on its axially open side forms the closed circumferential coolant channel.

2. The current transmission device according to claim 1, wherein the ribbed structure is formed by at least two ribs projecting from the surface, wherein the ribs are each arranged opposite one another and circulate in a closed manner such that they define between them a closed circumferential coolant channel which is open on one side and is covered in a coolant-tight manner on the open side by the respective contact carrier bearing thereagainst.

3. The current transmission device according to claim 2, wherein the ribs each form a sealing surface at the end faces of their axially projecting free ends, wherein the respective contact carrier bears against the sealing surfaces of two oppositely arranged ribs in a coolant-tight manner.

4. The current transmission device according to claim 3, wherein the contact carriers are designed as plates and each bear axially, in a coolant-tight manner, with a flat axial inner side against planar sealing surfaces of the ribbed structures, formed on the outer sides of the base carrier facing away from one another and each cover a coolant channel formed therebetween in a coolant-tight manner.

5. The current transmission device according to claim 4, wherein the coolant channels formed on the outer sides of the base carrier on the ribbed structures are in coolant connection with one another and a common coolant inlet and a common coolant outlet for the coolant channels arranged on each of the two axial outer sides are formed on the ribbed structures of an outer side of the base carrier

6. The current transmission device according to any one of claim 5, wherein the coolant channels formed on the ribbed structures each extend in a meandering manner in an axial top view with multiple loops arranged circumferentially one behind the other in such a way that the multiple loops come, at least in part, into contact with regions on the inner sides of the contact carriers on which the electrical sliding contacts are arranged on the outer sides of the contact carriers.

7. The current transmission device according to claim 6, wherein spray openings aligned in a with the electrical sliding contacts are, provided on the ribbed structures for controlled minimum lubrication of the electrical sliding contacts.

8. The current transmission device according to claim 1, wherein plastic is provided as a material for the base carrier and the base carrier is formed in one piece as an injection-molded component.

9. A current transmission device for transmitting electrical current to a rotor of an electric machine comprising:
two contact carriers having electrical sliding contacts for transmitting current to the rotor; and
a base carrier which carries and electrically insulates the contact carriers arranged between the contact carriers;
wherein the current transmission device has at least one closed circumferential coolant channel for cooling one of the contact carriers formed between the base carrier and a respective contact carrier, which bear against one another at least in sections, between an outer side of the base carrier and the respective contact carrier bearing thereagainst, in such a way that on the base carrier, on its outer side facing the respective contact carrier, a ribbed structure open on one side and projecting from a surface is provided, which ribbed structure, together with the respective contact carrier bearing thereagainst and covering it in a coolant-tight manner on its axially open side, forms the closed circumferential coolant channel.

10. The current transmission device according to claim 9, wherein the ribbed structures are formed by at least two ribs projecting from the surface, wherein the ribs are each arranged opposite one another and circulate in a closed manner such that they define between them the closed circumferential coolant channel which is open on one side and is covered in a coolant-tight manner on an open side by the respective contact carrier bearing thereagainst.

11. The current transmission device according to claim 10, wherein the ribs each form a sealing surface at end faces of their axially projecting free ends, wherein the respective contact carrier bears against the sealing surfaces of two oppositely arranged ribs in a coolant-tight manner.

12. The current transmission device according to claim 11, wherein the respective contact carriers is designed as a plate and bears axially, in a coolant-tight manner, with a flat axial inner side against planar sealing surfaces of the ribbed structures formed on the outer side of the base carrier and covers the coolant channel formed therebetween in a coolant-tight manner towards the outside.

13. The current transmission device according to claim 12, wherein the coolant channel formed in the outer side of the base carrier on the ribbed structures is in coolant connection with a common coolant inlet and a common coolant outlet for the coolant channel.

14. The current transmission device according to claim 13, wherein the coolant channel extends in a meandering manner in a axial top view with multiple loops arranged circumferentially one behind the other in such a way to contact regions on an inner side of the respective contact carrier.

15. The current transmission device according to claim 14, wherein spray openings aligned with the sliding contact on the ribbed structures provide controlled minimum lubrication of the electrical sliding contacts.

16. The current transmission device according to claim 15, wherein plastic is provided as a material for the base carrier and the base carrier is formed in one piece as an injection-molded component.
